(19) United States
(12) Patent Application Publication
(10) Pub. No.: US 2011/0195224 A1
(43) Pub. Date: Aug. 11, 2011

(54) SHELL, MOBILE COMMUNICATION TERMINAL CONTAINING THE SAME AND PREPARATION METHODS THEREOF

(76) Inventors: Bing Zhang, Shenzhen (CN); Feng Cheng, Shenzhen (CN); Ruijun Xing, Shenzhen (CN)

(21) Appl. No.: 13/120,802

(22) PCT Filed: Jul. 24, 2006
(86) PCT No.: PCT/CN2009/072919

§ 371 Date: Mar. 24, 2011

(30) Foreign Application Priority Data
Sep. 24, 2008 (CN) 200810222878.4

(51) Int. Cl. B32B 3/24; H04M 1/02; B29C 45/14; B32B 37/16

(52) U.S. Cl. 428/138; 264/261; 156/60; 156/242; 156/182

(57) ABSTRACT

A shell is provided. The shell includes a transparent substrate, and a first sheet formed on an upper surface of the substrate with a plurality of upper apertures formed thereon. The shell also includes a second sheet formed on a lower surface of the substrate with a plurality of lower apertures formed thereon. At least portions of the upper apertures are overlapped with at least portions of the lower apertures such that the overlapped and/or partly overlapped apertures form a predetermined pattern.

### TECHNICAL FIELD OF THE INVENTION

The present invention relates to an improved shell structure and preparation methods thereof, more particularly, to a shell of a mobile communication terminal and methods for forming the same.

### BACKGROUND OF THE INVENTION

Along with the development of the mobile communication technology and wide application thereof, requirements for the design of the mobile communication terminal are growing rapidly. At present, there are mainly three types of shapes for the mobile phones in the market. A first type is a clamshell phone, users may fold or unfold an upper cover and a lower cover which are connected to each other via a torsional connection. Another type is candy bar phone that users may input directly from a keyboard thereof. The third type relates to a slide phone, while communication or inputting, a keyboard on the upper surface of the lower cover may be uncovered by pushing the upper cover. Further, the shells of these phones may be divided into two categories, one type is a metal shell with relatively simple decoration, the other type relates to a plastic one which may be made in different colors respectively. However, there are few splendid patterns or only some simple decorating characters, which is not attractive or boring to normal users.

Besides, there exists shells for the mobile phones that are treated by coating or electroplating, for example, CN1583286A filed on Jun. 10, 2004 disclosed a spray method for the shell of the mobile phone that is anti-radiating and anti-electrostatic. However, coatings on the shell might flake while it is hit or dropped which may, as a result, negatively affects the appearance of the mobile phone.

Furthermore, Chinese utility model ZL200720120829.0 discloses a mobile phone shell 1′, as shown in FIG. 1. Multiple concave blind apertures 2′ (for example hexagons, circles and so on) are formed on the back shell of the mobile phone 1, and inside the concave blind apertures there set the decorations, such as crystals, colorful stones and so on, thus to beautify the mobile phones. However, these kinds of mobile phones are still opting to be worn out. Besides, it is inconvenient to substitute decorations thereof for these shells.

### SUMMARY OF THE INVENTION

In viewing thereof, the present invention provides a shell and a method for forming the same, the shell may be applied to the mobile communications. The shell is durable and the preparation method is simple, thus reducing manufacturing costs thereof accordingly.

Further, according to another embodiment of the invention, a shell having visual dynamic effect is disclosed, which provides comfortable and pleasing visual effect for users thereof.

According to a first aspect of the invention, a shell is provided, comprising: a transparent substrate; a first sheet formed on an upper surface of the substrate with a plurality of upper apertures formed thereon; and a second sheet formed on a lower surface of the substrate with a plurality of lower apertures formed thereon; wherein, at least a part of the upper apertures are overlapped with at least a part of the lower apertures such that the overlapped and/or partly overlapped apertures form a predetermined pattern.

Accordingly, the shell with visual dynamic effect is substantially comprised of a first sheet, a second sheet and a transparent substrate. And a plurality of upper and lower apertures are formed on the first sheet and the second sheet. When the first sheet and the second sheet are overlapped, the apertures provide an optical effect with a predetermined pattern, thus the users may be pleased by the obtained dynamic visual effect.

According to a second aspect of the invention, the first sheet may comprise a first transparent film layer and an upper mesh layer formed on the first transparent film layer, the upper apertures may be formed on the upper mesh layer; and the second sheet may comprise a second transparent film layer and an lower mesh layer formed on the second transparent film layer, the lower apertures may be formed on the lower mesh layer.

According to a third aspect of the invention, the first and second sheet may be made of translucent or opaque material.

According to a fourth aspect of the invention, the upper mesh layer and the lower mesh layer may be coloured mesh layers respectively.

Besides, as the above technical solution employs a layered structure, the first and second sheets may be made from translucent material or opaque material, the patterns with dynamical visual effect formed on the shell is obtained from the optical effect. Therefore, the patterns may not be worn out or scratched accidentally after long time usage which may as a result increase the lifespan of the shell.

According to a fifth aspect of the invention, the upper apertures on the upper mesh layer may form parallel upper aperture lines, the lower apertures on the lower mesh layer may form parallel lower aperture lines, and the upper aperture lines and the lower aperture lines may be intersected at a predetermined angle.

According to a sixth aspect of the invention, any adjacent three upper apertures in the two adjacent upper aperture lines may form an equilateral triangle, and any adjacent three lower apertures in the two adjacent lower aperture lines may form an equilateral triangle.

According to a seventh aspect of the invention, the formed pattern may be hexagon while the predetermined angle may fall within a range of 3-13° or 47-57°.

According to an eighth aspect of the invention, dimensions of the hexagon patterns may decrease while the angle fallen within the range of 3-13° may increase, and the dimensions of hexagon patterns may increase while the angle fallen within the range of 47-57° may increase.

According to a ninth aspect of the invention, the patterns may present star-like lattice patterns while the predetermined angle may fall within 13-20° or 40-47°.

According to a tenth aspect of the invention, the pattern may present substantially circular pattern while the predetermined angle may fall within 20-40°, and the size and location of the circular pattern may vary with the angle.

For the shell disclosed in the present invention, the intersected angle of the upper aperture lines with the lower aperture lines may be adjusted to obtain patterns with different geometric patterns. And the patterns may be customized according to different needs of the users to satisfy personalization or individualization to a maximum extent.

Moreover, according to an eleventh aspect of the invention, a method of forming a shell for a mobile communication terminal, comprising the following steps: providing a substrate; providing a first sheet with a plurality of upper apertures formed thereon and attaching the first sheet to an upper surface of the substrate; providing a second sheet with a plurality of lower apertures formed thereon and attaching the second sheet to a lower surface of the substrate in which at least a part of the upper apertures is overlapped with at least a part of the lower apertures so that the at least partially overlapped apertures form a predetermined pattern.

According to a twelfth aspect of the invention, the step of providing a first sheet further comprises: forming a first upper mesh layer and punching apertures in parallel lines on the first upper mesh layer; forming a first transparent film layer; and pressfitting the upper mesh layer and the first transparent film layer at a predetermined temperature to form the second sheet.

According to a thirteenth aspect of the invention, the step of providing a second sheet further comprises: forming a second lower mesh layer and punching apertures in parallel lines on the second lower mesh layer; forming a second transparent film layer; and pressfitting the lower mesh layer and the second transparent film layer at a predetermined temperature to form the second sheet.

Therefore, the shell with dynamic visual effect for the mobile communication terminals may be provided by forming a first and a second sheet with different punching angles by molding or punching, placing the sheets into the injection mold and forming the substrate by injection to form the shell for the mobile communication terminals. The shell having dynamic visual effect provided by the present invention enhances the visual impact, durability and also comfortableness which meet individualization requirements of normal users.

Part of the invention as well as the advantages will be described in detail; part will be understood from the following description or by practicing the invention.

### DESCRIPTION OF THE DRAWINGS

The aforementioned features and advantages of the invention as well as additional features and advantages thereof will be more clearly understood hereafter as a result of a detailed description of the following embodiments when taken conjunction with the drawings, wherein:

FIG. 1 is a schematic view of a conventional mobile phone shell 1.

FIG. 2 is a cross section view of a mobile phone according to one embodiment of the invention;

FIG. 3A is a schematic view of upper apertures 101 formed on the upper mesh layer 1 according to one embodiment of the invention;

FIG. 3B is a schematic view of the lower apertures 501 formed on a lower mesh layer 5 according to one embodiment of the invention, in which the upper aperture 101 and the lower aperture 501 are intersected with each other at a predetermined angle while the upper mesh layer 1 and the lower mesh layer 5 are overlapping; and

FIG. 4A-4C show plan views of patterns while the upper sheet 12 and lower sheet 56 are overlapping with each other.

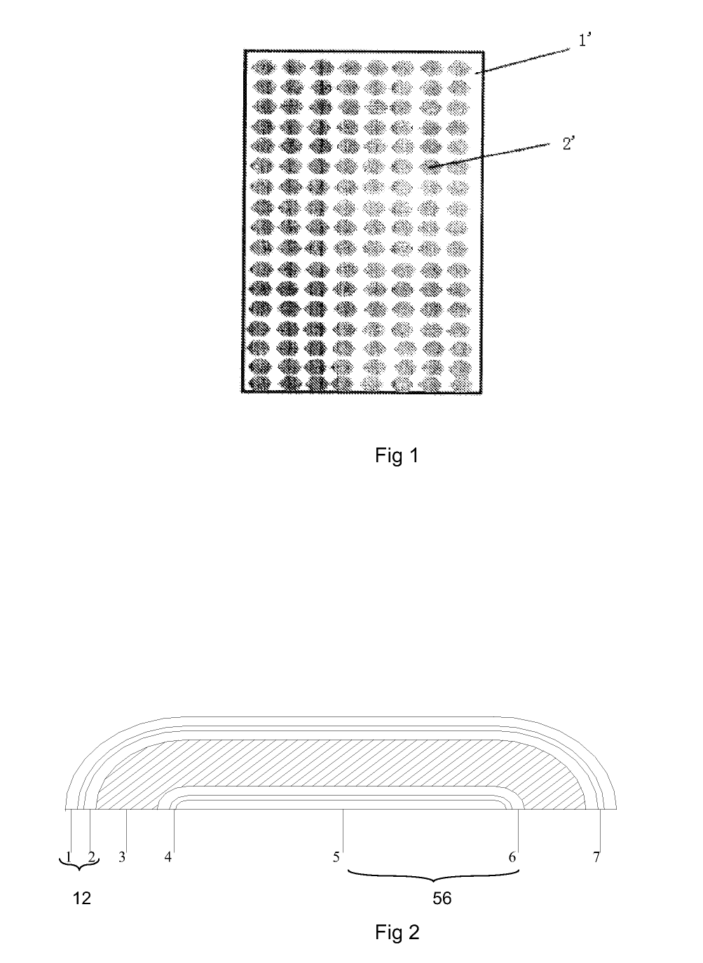

### DETAILED DESCRIPTION OF THE EMBODIMENTS

Some embodiments of the invention are described as follows, some examples are shown in the drawings, wherein, the components with the same or similar numerals designate the same or components of similar functions. Followed by description in conjunction with the drawings, which is only to explain the invention, not to limit the present invention.

A shell for a mobile phone and a method of forming the same according to one embodiment of the invention is described as follows. In the following description, a mobile phone is selected as a representative of a mobile communication terminal to describe the embodiments in the present invention. However, the invention is not limited hereto. For example the mobile communication terminals may be a pager, an intelligent terminal, a personal digital assistant and so on.

Along with the development of the mobile communication technology, the mobile phones are wildly used presently. Besides further requirements of the wireless communication technology, the requirement of the appearance of the mobile phones become higher, especially for the designs of the mobile phone shells, not only the duration but also the individualization is required.

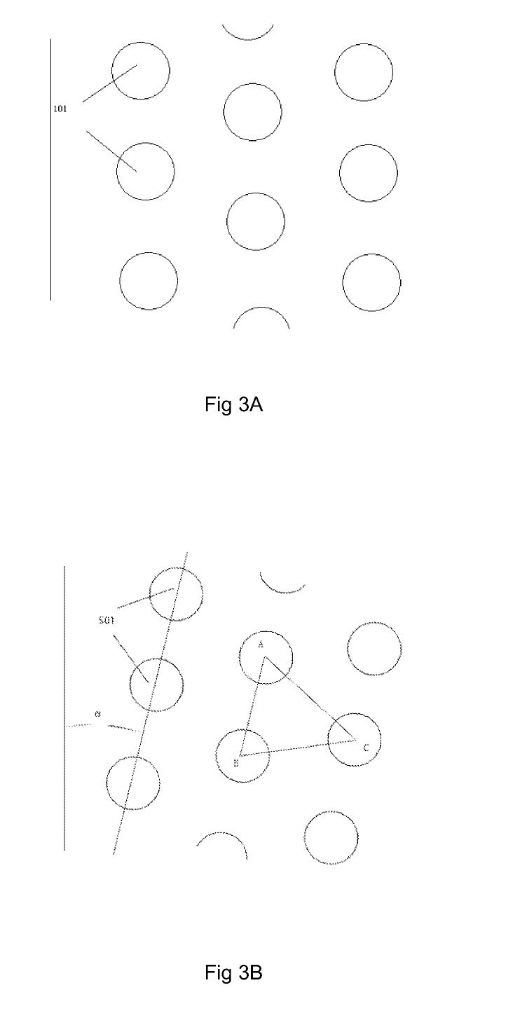

The structure and the preparation method of the mobile phone shell 100 according to some embodiments of the invention is described in conjunction with FIGS. 2-4. FIG. 2 shows a cross section view of a mobile phone according to one embodiment of the invention. FIG. 3A is a schematic view of upper apertures 101 formed on the upper mesh layer 1 according to one embodiment of the invention;

FIG. 3B is a schematic view of the lower apertures 501 formed on a lower mesh layer 5 according to one embodiment of the invention, in which the upper aperture 101 and the lower aperture 501 are intersected with each other at a predetermined angle while the upper mesh layer 1 and the lower mesh layer 5 are overlapping.

According to one embodiment of the invention, a mobile phone shell 100 is provided, the shell 100 comprises: a transparent substrate 3, a first sheet 12 formed on the upper surface of the substrate 3, a plurality of upper apertures 101 are formed on the first sheet 12; a second sheet 56 formed on the lower surface of the substrate 3, a plurality of lower apertures 501 are formed on the second sheet 56; at least a part of the upper apertures 101 and the lower apertures 501 are overlapped such that the overlapped and/or partly overlapped apertures will form a predetermined pattern.

Those skilled in the art can understand that the amount of upper apertures 101 and lower apertures 501 may be set according to the requirements. Besides, the amount of upper apertures 101 and lower apertures 501 may be the same or different.

Those skilled in the art can understand that: at least a part of the upper apertures 101 and the lower apertures 501 being overlapped such that the overlapped and/or partly overlapped apertures will form a predetermined pattern may comprise many situations, for example, a part of upper apertures 101 and a part of lower apertures 501 are overlapped such that the overlapped apertures of the upper aperture 101 and lower aperture 501 form a predetermined pattern; a part of upper apertures 101 and a part of lower apertures 501 are partly overlapped such that the partly overlapped apertures of the upper aperture 101 and lower aperture 501 form a predetermined pattern; a part of upper apertures 101 and a part of lower apertures 501 are overlapped and another part of upper apertures 101 and lower apertures 501 are partly overlapped such that the overlapped apertures and partly overlapped apertures of the upper aperture 101 and lower aperture 501 form a predetermined pattern; a part of upper apertures 101 and all lower apertures 501 are overlapped such that the overlapped parts of the upper apertures 101 and lower apertures 501 form a predetermined pattern, or a part of upper apertures 101 and a part of lower apertures 501 are overlapped and another part of upper apertures 101 and the rest of the lower apertures 501 are partly overlapped such that the overlapped apertures and partly overlapped apertures of the upper aperture 101 and lower aperture 501 form a predetermined pattern, of course in this case the amount of the upper apertures 101 is greater than the lower apertures 501; a part of upper apertures 101 and a part of lower apertures 501 are overlapped and the rest of upper apertures 101 and the rest of the lower apertures 501 are partly overlapped such that the overlapped apertures and partly overlapped apertures of the upper aperture 101 and lower aperture 501 form a predetermined pattern. Obviously the invention is not limit to the above situations, other alternative is omitted here for clarity purpose.

Besides, the predetermined pattern formed by the overlapped apertures and partly overlapped apertures of the upper aperture 101 and lower aperture 501 is the pattern formed in general, not every single shape of each upper aperture 101 and each lower aperture 501.

The shell 100 in the present invention employs multiple layered structure so the wear resistance of the mobile phone shell may be improved, and the predetermined pattern is obtained from the optical effect of overlapping upper apertures 101 and lower apertures 501, so that the shell 100 can not be worn out or scratched, which as a result improves the life span of the mobile phone shell 100.

According to an embodiment of the invention, the material for forming substrate 3 needs to provide with strong bonding force to the first sheet 12 and the second sheet 56. According to another embodiment of the invention, the substrate 3 is formed from transparent plastics, for example, the plastic material may be at least one selected from transparent carbonate (PC), acrylonitrile-butadiene-styrene(ABS) and polymethyl methacrylate(PMMA). What need to be pointed out is, any material which binds the first sheet 12, second sheet 56 may be used to form the substrate 12, the above mentioned material is only an example, not a limit of the protection scope of the present invention.

The detailed structure of the first sheet 12 and the second sheet 56 of the mobile phone shell 100 according to some embodiments of the invention is described in conjunction with FIG. 2.

The first sheet 12 comprises a first transparent film layer 2 and an upper mesh layer 1 formed on the first transparent film layer 2, the upper apertures 101 are formed on the upper mesh layer 1; and the second sheet 56 comprises a second transparent film layer 6 and lower mesh layer 5 formed on the second transparent film layer 6, the lower apertures 501 are formed on the lower mesh layer 5.

To present more clear pattern for the users, according to one embodiment of the invention, the first sheet 12 and the second sheet 56 are made from translucent or opaque material. The upper mesh layer 1 and the lower mesh layer may be coloured mesh layer. Users may choose different colours according to their needs to meet the individualization requirements.

According to an embodiment of the invention, the coloured mesh layer may be prepared by punching apertures on kinds of plastic sheets, the plastic sheet needs to have good film forming ability, tensility, temperature impact resistance so that it suits molding especially the complicated working conditions in the inner molding decoration (IMD). For example, the plastic sheet may be one or more selected from polycarbonate (PC), PET. Further, the color, the diameter of the formed apertures as well as the arrangement of the apertures of the upper mesh layer 1 and the lower mesh layer 5 may be selected according to the required appearance. (Following will describe more details)

According to an embodiment of the invention, the first transparent film layer 2 and 6 may be made from kinds of transparent plastics providing that the plastic sheet needs to have good film forming ability, tensility, temperature impact resistance so that it suits molding especially the complicated working conditions in the inner molding decoration (IMD). For example the plastic sheet may be one or more selected from polycarbonate (PC), polymethyl methacrylate(PMMA) and PET. The above mentioned material is only an example, not a limit of the protection scope of the present invention.

The preparation of first sheet 12, the second sheet 56 will be described in more details hereinafter. During mass production in the industry, plastics are usually shaped by injection molding. According to one embodiment in the invention, for molding shell 100 more conveniently, the upper mesh layer 1 and the first transparent film layer 2, the lower mesh layer 5 and the second transparent film layer 6 are integrally formed so that it will be molded faster. Therefore it may improve the productivity and yield rate accordingly.

According to an embodiment of the invention, the upper mesh layer 1 is bonded with the second transparent film layer 2 via adhesive agents to form the first sheet 12, the lower mesh layer 5 is bond with the second transparent film layer 6 via adhesive agents to form the second sheet 56. The adhesive agents may be any adhesive agent which can provide sufficient bonding force. The adhesive agent is required to have excellent temperature impact resistance, easy operability and good physical and chemical performance so that it suits molding under complicated working conditions especially the inner molding decoration. For example, the adhesive agents may be aqueous adhesive agent Aquapress ME from Germany PROELL Co., Ltd. While forming the first sheet 12 and second sheet 56, firstly coating the adhesive agent uniformly on the first transparent film layer 2 and second transparent film layer 6. To ensure the uniformity of the coated adhesive agent, the coating method may be one of printing method, mounting method and spraying method. After forming the integrated first sheet 12, the second sheet 56, inner mold decoration may be employed to form the mobile phone shell. (more detailed description hereinafter)

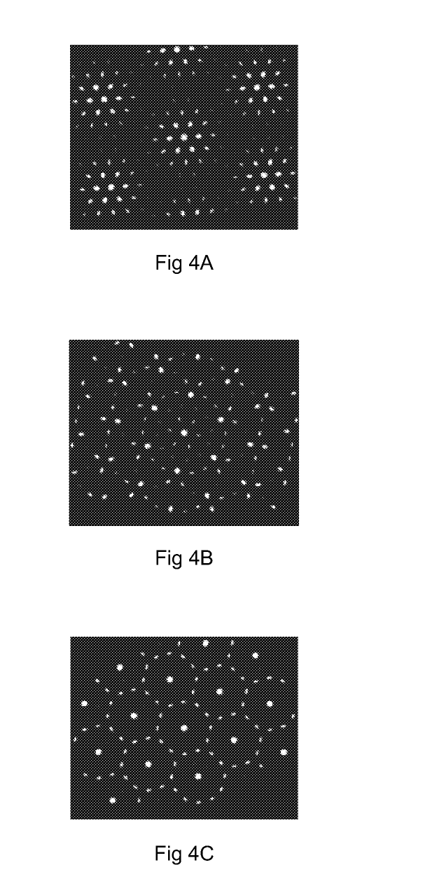

In conjunction with FIGS. 3 and 4, the distribution of the upper apertures 101 and lower apertures 501 of the mobile phone 100 are described. FIG. 3A a schematic view of upper apertures 101 formed on the upper mesh layer 1 according to one embodiment of the invention;

FIG. 3B is a schematic view of the lower apertures 501 formed on a lower mesh layer 5 according to one embodiment of the invention, in which the upper apertures 101 and the lower apertures 501 are intersected with each other at a predetermined angle while the upper mesh layer 1 and the lower mesh layer 5 are overlapping. FIG. 4A-4C show plan views of patterns while the upper sheet 12 and lower sheet 56 are overlapping with each other. According to the above description, to form optical superposed pattern, the plurality of the upper apertures 101 and the lower apertures 501 are formed on the upper mesh layer 1 and the lower mesh layer 5 respectively. At least a part of the upper apertures 101 and the lower apertures 501 are overlapped with each other such that the overlapped and/or partly overlapped apertures will form a predetermined pattern. The distribution of the upper apertures 101 and the lower apertures 501 is described with an example as follows, as shown in FIG. 3A. The upper apertures 101 are formed on the upper mesh layer 1 in parallel aperture lines.

As shown in FIG. 3B, the lower apertures 501 are formed on the lower mesh layer 5 in parallel aperture lines, and the upper aperture lines and the lower aperture lines are intersected at a predetermined angle α.

To describe the optical superposing effect of the upper aperture 101 and the lower aperture 501, an example is selected to explain the visual dynamic effect while the mobile phone 100 has the above mentioned aperture distribution according to one embodiment of the invention. The above mentioned material is only exemplified for illustration purpose rather than limitation to the scope of the invention. To obtain different dynamic visual effect, those skilled in the art can choose suitable intersecting angle, aperture diameters, aperture distribution by limited experiments (for example, limited computer simulation), and obtain the space distribution according to the present invention.

According to an embodiment of the present invention, the upper mesh layer 1 and lower mesh layer 5 are coloured, and the apertures formed have aperture diameters of 0.5 mm and aperture distances of 1.0 mm. As shown in FIGS. 3A and 3B, any adjacent three upper apertures in the two adjacent upper aperture lines form an equilateral triangle, and any adjacent three lower apertures in the two adjacent lower aperture lines form an equilateral triangle. The equilateral triangle ΔABC is exemplarily shown in FIG. 3B.

While the upper mesh layer 1 having upper apertures 101, the lower mesh layer 5 having the lower apertures 501 are overlapped with each other, the intersected angle of aperture lines has the following relation with the formed pattern:

(1) While the predetermined intersected angle α falls within 3-13° or 47-57°, the formed pattern is approximately hexagon. As shown in FIG. 4A. In the center of the hexagon pattern, the apertures are overlapping partly and the overlapped part is relatively large, thus more light can transmit through the overlapped part, while at the edge of the hexagon, as the overlapped part of the upper aperture 101 and the lower aperture 501 is decreasing, less light will transmit through the overlapped part. Testing result shows that the hexagon pattern diminishes while the angle increases in the case that the predetermined angle is within 3-13°, the hexagon pattern increases while the angle increases in the case that the predetermined angle is within 47-57°.

(2) While the intersected angle α falls within 13-20° or 40-47°, the pattern presents star-like lattice pattern. As shown in FIG. 4B, the lattice arrangement changes while the angle α changes.

(3) In the case that the intersected angle α is within 20-40°, the upper apertures 101 and the lower apertures 501 overlap with each other, the pattern is florid round circles formed by arranged points. As shown in FIG. 4C, and the size and location of the circle varies with the angle.

(4) Beside, as any adjacent three upper apertures in the two adjacent upper aperture lines form an equilateral triangle, and any adjacent three lower apertures in the two adjacent lower aperture lines form an equilateral triangle, while the predetermined angle of the upper aperture lines and the lower aperture lines is n, the pattern will be the same as while the predetermined angle is m, in which n and m satisfy the following equation:

n=60*i±m;

wherein, 0≦m<60, i=0, 1, 2 . . .

It should be noted that those skilled in the art can obviously arrange the upper aperture 101, the lower aperture 501 on portions of the first sheet 12 and the second sheet 56 to obtain the optical superposing pattern according to any design requirement.

The method of forming the mobile phone shell 1 is described as follows. According to an embodiment of the invention, a method of forming the shell 1 is provided, the method comprises the following steps: providing a substrate 3; providing a first sheet 12 with a plurality of upper apertures 101 and attaching the first sheet 12 to the upper surface of the substrate 3; providing a second sheet 56 with a plurality of lower apertures 501 and attaching the second sheet 56 to the lower surface of the substrate 3; and overlapping at least a part of the upper apertures 101 with the lower apertures 501 such that the overlapped and/or partly overlapped apertures form a predetermined pattern.

According to an embodiment of the invention, the material for forming substrate 3 should have properties of strong bonding force to the first sheet 12 and the second sheet 56. According to another embodiment of the invention, the substrate 3 is made of transparent plastics, for example, the plastic material may be selected from at least one of transparent carbonate (PC), acrylonitrile-butadiene-styrene (ABS) and polymethyl methacrylate (PMMA). It should be noted that any material which may firmly attach the first sheet 12, second sheet 56 may be used to form the substrate 3, the above mentioned material is only exemplified for illustration purpose rather than for limitation.

For the material forming the upper mesh layer 1, first transparent film layer 2 and lower mesh layer 5 of the first sheet 12, the second sheet 56, according to an embodiment of the invention, the mesh layer may be prepared by punching apertures on kinds of plastic sheets, the plastic sheet needs to have good film forming ability, tensility, temperature impact resistance so that it is adapted during molding, especially with complicated working conditions via inner molding decoration (IMD). For example, the plastic sheet may be selected from at least one of polycarbonate (PC), PET. Further, the color, the diameter of the formed apertures as well as the arrangement of the apertures of the upper mesh layer 1 and the lower mesh layer 5 may be selected according to the required appearance, which will be described in detail in following. According to an embodiment of the invention, the first transparent film layer 2 and 6 may be made of transparent plastics provided that the plastic sheet have excellent film forming ability, tensility, temperature impact resistance so that it suits molding especially the complicated working conditions in the inner molding decoration (IMD). For example the plastic sheet may be one or more selected from polycarbonate (PC), polymethyl methacrylate (PMMA) and PET. The above mentioned material is only exemplified for illustration purpose rather than limitation.

In the above structure of the mobile phone shell 100, the method of forming the mobile phone shell 100 comprises: selecting a first upper aperture mesh sheet 1 and a second lower aperture mesh sheet 5 with different punching angles, attaching the sheets 1, 5 with the transparent layer 2 and 6 respectively, molding and punching the first sheet 12 and the second sheet 56, finally forming the substrate 3 by injection molding between the first sheet 12 and the second sheet 56.

In the above method, the step of providing a first sheet 12 further comprises: forming a first upper mesh layer 1, the material of the upper mesh layer 1 may be any one of above mentioned polycarbonate (PC) or PET and so on, and punching apertures in parallel lines on the first upper mesh layer 1. During the process thereof, a puncher may be used. The punching aperture, distance and the arrangement of the apertures may be adjusted according to the design needs. Then, a first transparent film layer 2 is formed. And the upper mesh layer 1 and the first transparent film layer 2 are pressfitted at a predetermined temperature and pressure to form the first sheet 12.

Further, the step of providing a second sheet 56 further comprises: forming a second lower mesh layer 5, similarly, according to the predetermined punching aperture, distance and the arrangement of the apertures punching lower aperture lines on the second lower mesh layer 5. The punched lower aperture lines and the upper aperture lines are intersected at a predetermined angle α. Then, a first transparent film layer 6 is formed, the upper mesh layer 5 and the first transparent film layer 6 are pressfitted at a predetermined temperature and pressure to form the second sheet 56.

While forming the first sheet 12 and the second sheet 56, to obtain the above mentioned regular pattern, the upper aperture lines are preferably punched such that three adjacent upper apertures of two adjacent upper aperture lines form a equilateral triangle. And the lower aperture lines are preferably punched out such that three adjacent lower apertures of two adjacent lower aperture lines form a equilateral triangle. The equilateral triangle structure is an example for explaining the distribution and the superposing pattern. Those skilled in the art may adjust the sizes of the apertures, distances and space distribution according to the design requirements.

During the bonding step while forming the first sheet 12, the second sheet 56, firstly the adhesive agent is coated uniformly on the first transparent film layer 2 and second transparent film layer 6. To ensure the uniformity of the coated adhesive agent, the coating method may be one of printing method, adhering method and spraying method. After forming the first sheet 12 and the second sheet 56, inner mold decoration may be employed to form the mobile phone shell. That is, compress two intersected coloured mesh layer 1, 5 having an intersection angle of α with transparent layers 2, 6 which has a uniformly coated adhesive agent under certain temperature and pressure to integrally form the sheets, i.e. the first sheet 12 and the second sheet 56.

The method for forming coloured mesh layers with predetermined intersected angles is described in more details as follows.

(1) placing the coloured mesh layers 1 and 5 in the puncher with preset parameters like punching aperture, distance and arrangement and so on for punching; besides, what need to be explained is, the coloured mesh layers 1 and 5 may be provided by the suppliers with the plurality of the aperture lines with intersected punching angle α being already formed thereon;

(2) while bonding the coloured mesh layers 1, 5 with the first and second transparent film layers 2, 6 respectively, the edge of the layers 1 and 5 and may be placed to be parallel with the edges of the transparent film layers 2 and 6 and then they are pressfitted or compressed together. Alternatively, the coloured mesh layers 1,5 with same punching angles may be provided by the suppliers, while bonding, the edge of the layer 1 and may be placed to be parallel with the edges of the transparent layers and then they are compressed together, then the edges of the second coloured mesh layer 5 are rotated by the predetermined angle α. Then it is pressfitted or compressed together with the already pressfitted or compressed three layers. Apparently, comparing the two methods, because the latter needs to rotate the lower mesh layer 5 by a certain angle, the material of the layer 5 may be wasted to some extent.

However, it should be noted that, besides the aforementioned methods, before injection molding, other methods may be employed to prepare the sheets from the mesh layers and the transparent layers. When the sheets are overlapping with each other, certain patterns may follow. Therefore, the aforementioned methods are only exemplified for illustration rather than limitation.

Then, the first sheet 12 is placed into the high-pressure mould and is molded under predetermined temperature and pressure. Further, trimming is performed to the molded first sheet 12 to obtain the desired mobile phone shell. The trimming process cuts the wastes of the molded sheet to obtain the desired shape and dimension that are suitable for injection molding.

Similarly, the second sheet 56 is placed into the high-pressure mould and is molded under predetermined temperature and pressure. Then, trimming is performed to the molded second sheet 56 to obtain the desired shape matching the first sheet 12. The molding process is described as follows:

placing the sheet in the mould, obtaining a shape that is suitable for inner mold decoration (IMD) via heating and adding pressure.

At last, a transparent layer of plastic is formed between the first sheet 12 and the second sheet 56 by inner mold decoration after molding to form the substrate 3. Thus, the waperture process for forming the mobile phone shell 100 is finished.

An example with detailed and completed data is used to simply explain the manufacturing process of the mobile phone shell 100.

(1) Firstly, transparent PC sheets with a thickness of 0.178 mm are selected to form the first and second transparent film layer 2, 6, the PC sheet may be provided by American GE Company with Model DMX 1HD00MY-112.

(2) Locating apertures and aqueous adhesive agent 7 which is Aquapress ME from Germany PROELL Co., Ltd are printed on the sheet 2 and 6, the thickness of the adhesive agent is about 15 μm, and then the coated sheets are baked under 80° C. for 30 minutes to dry for further usage.

(3) Then, black PC aperture mesh sheets 1, 5 with a thickness of 0.254 mm are selected to form the upper mesh layer 1, the lower mesh layer 5 according to the present invention. The punching angle of the sheet 5 is 8° anticlockwise relative to the layer 1, the aperture has a diameter of 0.5 mm, the aperture distance is 1.0 mm, every three adjacent apertures form an equilateral triangle. The sheets may be provided by Sigma company, Shenzhen, China.

(4) The sheets 1, 5 are bonded respectively with the sheets 2, 6 printed with aqueous adhesive agent to obtain the first sheet 12 and the second sheet 56 respectively. What needs to pay attention is that, while bonding, the temperature is adjusted to be 120° C. in the mould, and the pressure is adjusted to be 15 Kg/cm², the pressure-holding time is adjusted to be 30 seconds.

(5) Afterwards, a CCD puncher is used to punch the locating apertures on the first sheet 12 and the second sheet 56, and the first sheet 12 and second sheet 56 are cut into parcels with sizes of 100 mm×170 mm.

(6) The obtained first sheet 12 and the second sheet 56 are placed respectively into the high-pressure mould, setting the preheating time to be 15 seconds with the low-pressure to be adjusted to 10 Kg/cm², low pressure holding time to be 4 seconds, high pressure is adjusted to be 20 Kg/cm², the high pressure holding time is adjusted to be 6 seconds, and the pressure leading time is adjusted to be 5 seconds, the upper mould temperature is adjusted to be 125° C., while the lower mould temperature is adjusted to be 115° C.

(7) the first sheet 12 and the second 56 are placed respectively into the punching mould to cut the waste edges, the punching pressure is adjusted to be 5 Kg, the obtained sheets are placed into the injection mould for transparent plastic injection molding. The plastic for injection may be transparent PC plastic provided by American GE with a Model of X7300/CL.

Therefore, a mobile phone shell 100 with dynamic visual effect is provided accordingly.

From the above description, the shell with dynamic visual effect for the mobile communication terminals may be provided by: forming a first and a second sheet with different punching angles by molding or punching, placing the sheets into the injection mold and forming the substrate by injection molding, thus to form the shell for the mobile communication terminals. The shell having dynamic visual effect disclosed in the present invention enhances the visual impact, durability and also comfortableness which meet the individualization requirements.

It will be apparent to those skilled in the art that variations and modifications of the present invention may be made without departing from the scope or spirit of the present invention. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A shell comprising:
a transparent substrate;
a first sheet formed on an upper surface of the substrate with a plurality of upper apertures formed thereon; and
a second sheet formed on a lower surface of the substrate with a plurality of lower apertures formed thereon,
wherein at least portions of the upper apertures are overlapped with at least portions of the lower apertures such that the overlapped and/or partly overlapped apertures form a predetermined pattern.

2. The shell according to claim 1, wherein,
said first sheet comprises a first transparent film layer and an upper mesh layer formed on the first transparent film layer, said upper apertures are formed on the upper mesh layer, and
said second sheet comprises a second transparent film layer and a lower mesh layer formed on the second transparent film layer, said lower apertures are formed on the lower mesh layer.

3. The shell according to claim 1, wherein said first and second sheet are made of a translucent or opaque material.

4. (canceled)

5. The shell according to claim 2, wherein
said upper apertures on the upper mesh layer form parallel upper aperture lines,
said lower apertures on the lower mesh layer form parallel lower aperture lines, and
said upper aperture lines and the lower aperture lines are intersected at a predetermined angle.

6. The shell according to claim 5, wherein any adjacent three upper apertures in the two adjacent upper aperture lines form an equilateral triangle, and any adjacent three lower apertures in the two adjacent lower aperture lines form an equilateral triangle,
wherein, said pattern presents a star-like lattice pattern while said predetermined angle falls within 13-20° or 40-47°.

7. The shell according to claim 5, wherein the formed pattern is hexagon while said predetermined angle falls within a range of 3-13° or 47-57°,
wherein dimensions of said hexagon pattern decreases while the angle fallen within the range of 3-13° increases, and the dimensions of said hexagon pattern increases while the angle fallen within the range of 47-57° increases.

8-9. (canceled)

10. The shell according to claim 1, wherein, said pattern presents substantially circular pattern while said predetermined angle falls within 20-40°, and size and location of the circular pattern vary with said angle.

11. The shell according to claim 6, wherein the pattern presented when the predetermined angle is n is the same as the pattern presented when the predetermined angle is m, if n and m satisfy the following formula:
n=60*i±m;
wherein, 0≦m<60, and i is a non-negative integer.

12. The shell according to claim 1, wherein, said substrate includes at least one material selected from polycarbonate, acrylonitrile-butidiene-styrene and polymethyl methacrylate.

13. The shell according to claim 1, wherein said first sheet and said second sheet are respectively attached to the upper and lower surfaces of said substrate via inner molding decoration.

14. The shell according to claim 2, wherein, said first and second transparent film layers are made from a transparent plastic material.

15. The shell according to claim 14, wherein, said transparent plastic material is selected from at least one of polycarbonate, acrylonitrile-butadiene-styrene and PET.

16. A mobile communication terminal comprising the shell according to claim 1.

17. A method of forming a shell for a mobile communication terminal, comprising the following steps:
providing a substrate;
providing a first sheet with a plurality of upper apertures formed thereon;
attaching the first sheet to an upper surface of the substrate;
providing a second sheet with a plurality of lower apertures formed thereon; and
attaching the second sheet to a lower surface of the substrate,
wherein at least portions of the upper apertures are overlapped with at least portions of the lower apertures so that the at least partially overlapped apertures form a predetermined pattern.

18. (canceled)

19. The method according to claim 17, wherein said substrate is formed by injection molding between the first sheet and the second sheet via inner mold decoration.

20. The method according to claim 17, wherein the step of providing a first sheet further comprises:
forming an upper mesh layer and punching apertures in parallel lines on the upper mesh layer;
forming a first transparent film layer; and
pressfitting the upper mesh layer and the first transparent film layer at a predetermined temperature to form the first sheet.

21. The method according to claim 17, wherein the step of providing a second sheet further comprises:
forming a lower mesh layer and punching apertures in parallel lines on the lower mesh layer;
forming a second transparent film layer; and
pressfitting the lower mesh layer and the second transparent film layer at a predetermined temperature to form the second sheet.

22. The method according to claim 20, wherein three adjacent upper apertures of two adjacent upper aperture lines form an equilateral triangle.

23. (canceled)

24. The method according to claim 20, further comprising:
placing the first sheet into a high-pressure mould to be molded under a predetermined temperature and pressure; and
performing trimming to the molded first sheet to obtain a predetermined shape.

25. The method according to claim 20, further comprising:
placing the second sheet into a high-pressure mould to be molded under a predetermined temperature and pressure; and
performing trimming to the molded second sheet to obtain a predetermined shape.

26-27. (canceled)
